(19) United States
(12) Patent Application Publication
(10) Pub. No.: US 2004/0264748 A1
(43) Pub. Date: Dec. 30, 2004

(54) Fingerprint input apparatus and personal authentication system using the same

(75) Inventors: Makoto Ogura, Kanagawa (JP); Tadashi Kosaka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/873,157

(22) Filed: Jun. 23, 2004

(30) Foreign Application Priority Data
Jun. 27, 2003 (JP) 2003-185013
Jun. 1, 2004 (JP) 2004-163216

(51) Int. Cl. G06K 9/00

(52) U.S. Cl. 382/124

(57) ABSTRACT

A fingerprint input apparatus which is smaller than the conventional one and in which a stable and fine image can be obtained is provided at a reasonable price. The fingerprint input apparatus has: solid state image pickup devices on which a finger of a fingerprint input target person is put; LED chips for emitting light into the finger; a solid state image pickup device substrate on which the solid state image pickup devices are arranged; and a wiring substrate on which the solid state image pickup device substrate and the LED chips are arranged, wherein while relatively moving positions of a fingertip of the finger and the solid state image pickup devices, the light emitted from the LED chip and scattered from the inside of the fingertip is received by the solid state image pickup devices, thereby reading a fingerprint image of the finger. A frame-shaped member is arranged between the LED chip and the solid state image pickup device substrate on the wiring substrate. The frame-shaped member has the same or almost the same height as that of a surface of the solid state image pickup device substrate with which the fingertip is come into contact and spatially partitions the LED chip and the solid state image pickup devices.

### BACKGROUND OF THE INVENTION

1. Field of the Invention

The invention relates to a fingerprint input apparatus in which scattered light, from a finger, of light irradiated to the finger from illuminating means, more precisely, the scattered light from an inside of a fingertip is received by a solid state image pickup device. The invention also relates to a personal authentication system using such an apparatus.

More particularly, the invention relates to a fingerprint input apparatus in which a position of a finger, more precisely, a fingertip and a position of a solid state image pickup device are relatively moved and scattered light, from the finger, of light irradiated to the finger from illuminating means, more precisely, the scattered light from the inside of the fingertip is received by the solid state image pickup device. The invention also relates to a personal authentication system using such an apparatus.

2. Related Background Art

In recent years, in association with the spread of economic activities such as electronic commerce and the like owing to the remarkable progress of information technology, the necessity of digitization of personal authentication for preventing illegal use of the information is also increasing.

Hitherto, various methods of inputting an image of a fingerprint have been used as techniques of digitizing the personal authentication. However, for example, an apparatus as disclosed in JP-A-2000-11142 as a Japanese Laid-Open Patent uses a total internal reflection prism and has such a drawback that a shape of the apparatus is large, a forged fingerprint molded with a resin or the like cannot be discriminated, and the like.

As a small fingerprint input apparatus of high reliability which has improved such a drawback, as disclosed in JP-A-2000-217803 as Japanese Laid-Open Patent, there has been proposed a method whereby a finger is held in contact with a position near a surface of a 2-dimensional solid state image pickup device, a near-infrared radiation is irradiated to the finger, and scattered light from the inside of a fingertip is received. Such a method will be described with reference to FIG. 9.

In the fingerprint input apparatus shown in FIG. 9, solid state image pickup devices 1a which are two-dimensionally arranged at predetermined intervals (p) are formed on a surface of a solid state image pickup device substrate 1. A cover glass 100 is adhered and fixed over the solid state image pickup devices 1a with a transparent sealing material 41. The solid state image pickup device substrate 1 is fixed onto a wiring substrate 3 and electrically connected to a wiring 3a on the wiring substrate 3 by a wire 21. An LED chip 10 which emits an infrared ray or a near-infrared radiation for illumination is also fixed onto the wiring substrate 3, connected to the wiring 3a on the wiring substrate 3 by a wire 12, and protected by a sealing resin 11. Light 10a which is irradiated from the LED chip 10 enters a finger 20, is diffused therein, and enters as scattered light 10b into the cover glass 100 through a fingerprint 20a of the finger 20. The incident light reaches the solid state image pickup devices 1a through the cover glass 100 and is photoelectrically converted here, so that an electric signal of a fingerprint image is obtained.

It is necessary that the cover glass 100 has not only a function for protecting the solid state image pickup devices 1a from being electrically or mechanically broken when the finger 20 or the like is come into contact with the devices 1a but also a function as an optical filter for removing disturbance light other than the fingerprint image. However, in to obtain the clear fingerprint image, it is demanded that a thickness (t) of cover glass 100 is extremely thin. In order to provide a clear image and a sufficient protection of the image pickup device, an expensive material such as fiber optic plate (FOP) or the like, which transmits the image desirably even if a thickness of the cover glass increases, has to be used.

As a technique for realizing low costs and miniaturization, there have been proposed apparatuses of the sweep type in which positions of a fingertip and solid state image pickup devices are relatively moved and an image of the whole fingertip is obtained by synthesizing continuous partial images of the moving fingertip (for example, refer to JP-A-2002-216116 and JP-A-2002-133402 as Japanese Laid-Open Patents). According to such techniques, since it is sufficient that the solid state image pickup devices of a 2-dimensional array which used to be needed as much area as about a size of finger have only the width of finger, the costs of the solid state image pickup devices, the fiber optic plate (FOP), and the like are reduced. Besides the foregoing optical systems, as sweep types, input systems such as electric capacitance system, thermal sensitive system, and the like have also been known.

However, the above conventional methods have the following problems in the case of realizing the miniaturization and the low costs.

1) In the case of the optical system, since the illuminating means and the solid state image pickup devices are close to each other due to the miniaturization, unnecessary light enters the solid state image pickup devices and a stable and clear fingerprint image cannot be obtained.

2) In the case of the system in which the fingertip is moved, there is a fear that the finger is hurt by a corner of a reading surface which is come into contact with the finger.

3) There is also a fear that the reading surface, the illuminating means, or the like is damaged or, in the worst case, broken by a pressure which is frequently applied by the fingertip or foreign matter.

4) Since it is necessary to pay enough attention in manufacturing so that the sealing material or the like such as wire bonding or the like for protection of the electrical connecting portions is not adhered onto the reading surface or overflowed from desired positions, assembling performance is low. It is an obstacle to the realization of the low costs.

5) Since a flat portion is small, sticking which causes irregularity in a moving speed of the fingertip is easily caused and a stable image cannot be obtained.

With respect to the above problems 1) to 5), the conventional methods do not provide sufficient countermeasures. Also in the foregoing Official Gazettes of Japanese Patents, explanation of specific countermeasures for the above-mentioned problems is not disclosed at all or insufficient if any.

### SUMMARY OF THE INVENTION

The invention is made in consideration of the above problems and it is an object of the invention to provide a fingerprint input apparatus which is smaller than the conventional apparatuses and in which a stable and fine image can be obtained at a reasonable price.

To accomplish the above object, according to the invention, there is provided a fingerprint input apparatus comprising: solid state image pickup devices; illuminating means for irradiating light to a finger; a solid state image pickup device substrate on which the solid state image pickup devices are arranged; and a wiring substrate on which the solid state image pickup device substrate and the illuminating means are arranged, in which scattered light, from an inside of the finger, of the light irradiated to the finger from the illuminating means is received by the solid state image pickup devices, thereby reading a fingerprint image of the finger, wherein the fingerprint input apparatus further has a member which is arranged on the wiring substrate at least in a position between the illuminating means and the solid state image pickup device substrate, and the member has the same or almost the same height as that of a surface of the solid state image pickup device substrate with which the finger is come into contact and spatially partitions the illuminating means and the solid state image pickup devices.

It is desirable that after the solid state image pickup device substrate is electrically connected to the wiring substrate, the member is arranged by molding so as to also seal the electrical connecting portion.

It is desirable that the member shields at least unnecessary light other than the light which is irradiated from the illuminating means to the finger against the solid state image pickup devices.

The member can be formed in a frame shape which surrounds peripheries of the solid state image pickup device substrate and the illuminating means. A resin can be filled into the frame of the member formed in the frame shape and hardened. It is preferable that the resin is made of a material which can shield at least the light of the illuminating means.

It is desirable that the illuminating means is means for irradiating an infrared ray and/or a near-infrared radiation.

It is preferable that a silicon substrate is arranged as a protective member onto the surface of the solid state image pickup device substrate with which the fingertip is come into contact. It is desirable that a thickness of silicon substrate is equal to or more than 30 μm and is equal to or less than 200 μm.

The member can have conductive means.

A personal authentication system according to the invention is characterized by using one of the above fingerprint input apparatuses. It is preferable that this personal authentication system further comprises: fingerprint registering means for previously registering a fingerprint image of the finger read out by the fingerprint input apparatus as identification information of a specimen; and fingerprint verifying means for verifying whether the fingerprint image of the finger read out by the fingerprint input apparatus coincides with the image registered in the fingerprint registering means or not and outputting a verification result as a personal authentication signal.

### BRIEF DESCRIPTION OF THE DRAWINGS

FIG. 1 is a cross sectional view showing a fingerprint input apparatus according to the first embodiment of the invention;

FIG. 2 is a perspective view showing the fingerprint input apparatus according to the first embodiment of the invention;

FIG. 3 is a cross sectional view showing a fingerprint input apparatus according to the second embodiment of the invention;

FIG. 4 is a perspective view showing the fingerprint input apparatus according to the second embodiment of the invention;

FIG. 5 is a cross sectional view showing a fingerprint input apparatus according to the third embodiment of the invention;

FIG. 6 is a cross sectional view showing a fingerprint input apparatus according to the fourth embodiment of the invention;

FIG. 7 is a block diagram showing a construction of a personal authentication system using a fingerprint input apparatus according to the fifth embodiment of the invention;

FIG. 8 is a block diagram showing a construction of a peripheral circuit unit of the fingerprint input apparatus according to the fifth embodiment of the invention; and

FIG. 9 is a cross sectional view showing a conventional fingerprint input apparatus.

### DETAILED DESCRIPTION OF THE PREFERRED EMBODIMENTS

Embodiments of a fingerprint input apparatus according to the invention will be described hereinbelow with reference to the drawings.

(First Embodiment)

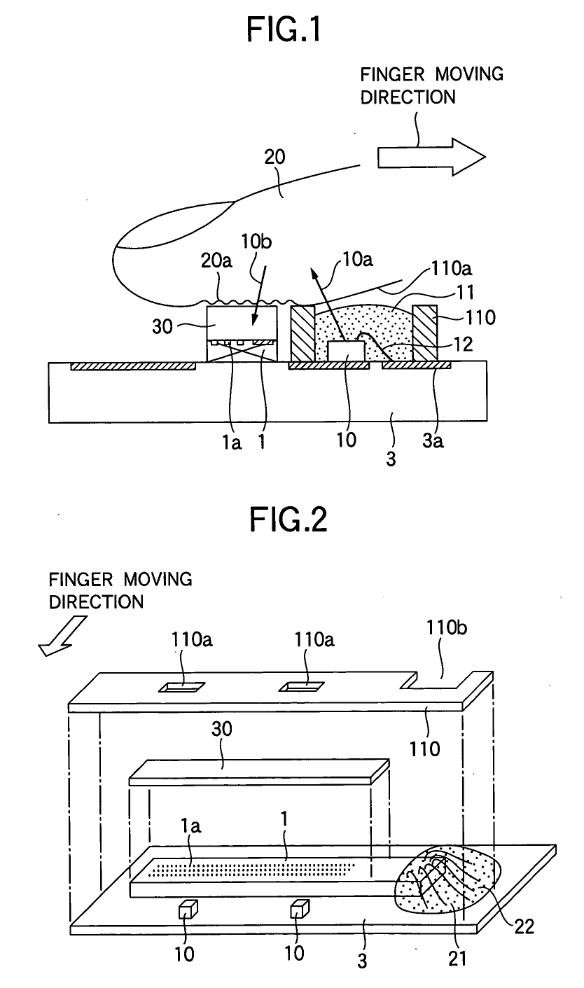

FIG. 1 is a cross sectional view of a fingerprint input apparatus according to the first embodiment and FIG. 2 is a perspective view thereof.

In the fingerprint input apparatus shown in FIGS. 1 and 2, the solid state image pickup device substrate 1 and the LED chips 10 are arranged on the wiring substrate 3. A plurality of solid state image pickup devices 1a which are arranged in a line shape are formed on the solid state-image pickup device substrate 1. The LED chip 10 has an LED as illuminating means which emits an infrared ray and/or near-infrared radiation.

As shown in FIG. 2, on the solid state image pickup device substrate 1, an electrode portion arranged in an edge portion in the longitudinal direction is electrically connected to the wiring 3a on the wiring substrate 3 by the wire 21. Similarly, as shown in FIG. 1, an electrode portion of the LED chip 10 is also electrically connected to the wiring 3a on the wiring substrate 3 by the wire 12.

For convenience of explanation, in FIG. 2, the apparatus is illustrated in such a form that the LED chips have previously been coated with a sealing resin 22. However, it is preferable to use a method whereby after a frame-shaped member 110 is arranged, a sealing resin is flowed into the frame portion as will be explained hereinafter.

On the solid state image pickup device substrate 1, a protective layer 30 is arranged on the reading surface with which the finger 20 is come into contact. A glass, a thin SiO₂ film, a thin SiON film, a fiber optic plate (FOP) or the like can be used as a material of the protective layer 30. The protective layer 30 is adhered onto the solid state image pickup devices 1a of the solid state image pickup device substrate 1 with an adhesive agent which transmits the infrared/near-infrared radiation.

To realize a further low price and read out a further fine image, the protective layer 30 needs to satisfy the following items 1) to 6).

1) When considering a leakage (crosstalk) of the light into the adjacent solid state image pickup devices, a refractive index is large in order to suppress a light extension between the incidence to the outgoing of the light.

2) To obtain a clear image, unnecessary light other than the illumination light does not enter.

3) There are friction scratch resistance and weatherability as a protective layer 30.

4) A low price.

5) Easy workability.

6) When considering warpage/deformation, a coefficient of linear expansion is close to that of the solid state image pickup device substrate 1.

A silicon substrate is particularly preferable as a material which satisfies those items. The silicon substrate can be worked to a desired thickness by backgrind or backwrapping. Since the silicon substrate transmits the infrared/near-infrared radiation and shuts out the visible light, it can shut out unnecessary light such as disturbance light and the like. Since the refractive index is equal to about 3.4, even when the silicon substrate has a thickness of 1.5 to 2 times as large as that of the glass, an equivalent resolution can be obtained. In the case of using the silicon substrate as a protective layer 30, the substrate having a thickness of 30 to 200 μm can be used and, particularly, a thickness of 70 to 150 μm is preferable.

As shown in FIGS. 1 and 2, the member in a frame shape (hereinafter, referred to as “frame-shaped member”) 110 is arranged between the solid state image pickup device substrate 1 and the LED chips 10. That is, the member 110 has such a stairway portion that a difference between a height of surface from the wiring substrate 3 and a height of surface of the protective layer 30 on the solid state image pickup device substrate 1 lies within a range of 200 μm, that is, the member 110 has the height that is substantially the same, in other words, the same as or is almost equal to that of surface of the protective layer 30 on the substrate 1, and the member 110 spatially partitions the solid state image pickup device substrate 1 and the LED chips 10.

As shown in FIG. 2, the frame-shaped member 110 is formed in the frame shape including: two first openings 110a which surround the whole peripheries except for the upper portions of the two LED chips 10; and a second opening 10b which surrounds the periphery of the sealing resin 22 that covers an electrode portion of the solid state image pickup device substrate 1.

The frame-shaped member 110 forms a substantial continuous surface between the member 110 and the protective layer 30 and also has a function as a bank for preventing the outflow of the sealing resin 11 of the LED chips 10 and the sealing resin 22 of the solid state image pickup device substrate 1. Further, the frame-shaped member 110 also has a light-shielding function for preventing the unnecessary light from the LED chips 10 as illuminating means from entering the solid state image pickup devices 1a. A colored material such as PC (polycarbonate), ABS resin, or the like can be used as a material of the member 110.

According to the embodiment, therefore, since the frame-shaped member 110 with the above construction is arranged between the solid state image pickup device substrate and the LED chips, the following effects are obtained.

1) Since the surface which is substantially continuous to the reading surface of the small contact area is constructed, the finger can move smoothly and the occurrence of a defective image due to the sticking or the like is reduced.

2) Since the frame-shaped member 110 has the function of the bank, after the frame-shaped member 110 is arranged onto the wiring substrate 3, if the sealing resin 11 is dropped and hardened, the sealing resin 11 on the LED chip 10 is not extended to the unnecessary portion of the wiring substrate 3. Therefore, assembling performance on manufacturing is improved.

3) Since the unnecessary light from the LED chips 10 does not enter the solid state image pickup devices 1a, the more clear image can be obtained.

(Second Embodiment)

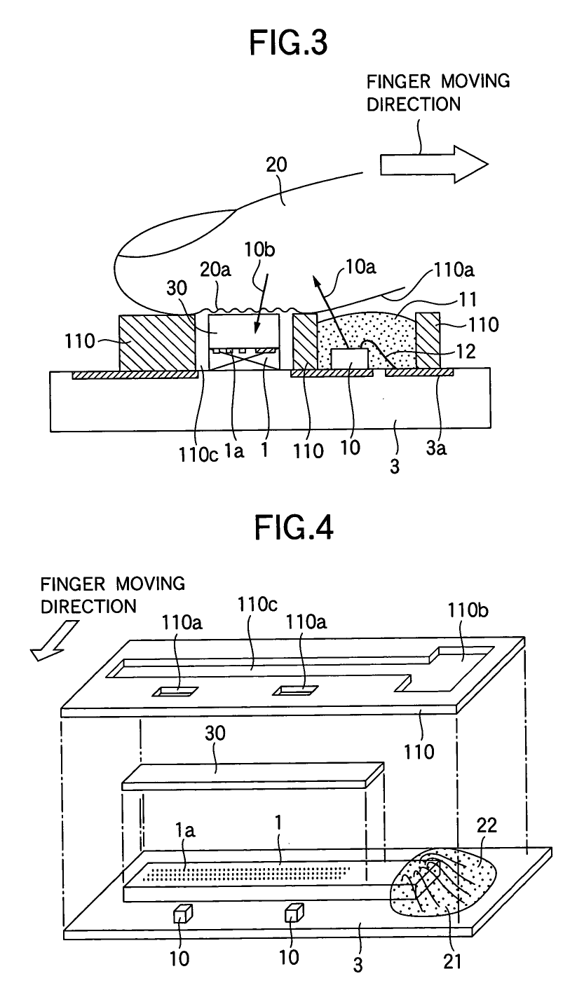

FIG. 3 is a cross sectional view of a fingerprint input apparatus according to the second embodiment and FIG. 4 is a perspective view thereof.

The fingerprint input apparatus shown in FIGS. 3 and 4 has a whole construction similar to that in the foregoing first embodiment (refer to FIGS. 1 and 2) but differs therefrom with respect to a point that the frame-shaped member 110 formed in the frame shape is further constructed so as to surround the periphery of the solid state image pickup device substrate 1. That is, the frame-shaped member 110 in the embodiment is formed in the frame shape including a third opening 110c which surrounds the periphery of the solid state image pickup device substrate 1 in addition to the two first openings 110a and 110a for the two LED chips 10 and 10 mentioned above and the second opening 110b for the sealing resin 22 that covers the electrode portion of the solid state image pickup device substrate 1.

Therefore, according to the second embodiment, in addition to the effects of the first embodiment, the following advantages 1) to 3) can be obtained.

1) It is possible to prevent the finger from being hurt in the edge surface portions of the protective layer 30 and the solid state image pickup device substrate 1.

2) Since the larger continuous surface on which the finger moves is formed, the sticking is reduced and the clear image can be obtained.

3) Since the force is not carelessly applied only to the reading surface, the durability against the external force is improved, and the like.

As a modification of the embodiment, it is also possible to construct the apparatus in such a manner that conductive means is added by mixing a conductive material such as carbon or the like into the frame-shaped member 110, plating the surface of the member 110 with metal, or adhering a conductive member such as a metal foil or the like onto the surface of the member 110, and the member 110 is mounted onto the ground through the wiring substrate 3. According to this structure, static electricity can be discharged from the finger and the solid state image pickup devices 1a and the LED chips 10 can be protected from electrostatic destruction.

As another modification of the embodiment, the stairway portion between the frame-shaped member 110 and the protective layer 30 can be sequentially changed in the moving direction of the finger 20. According to this method, the finger is further adhered and the clear image can be obtained.

(Third Embodiment)

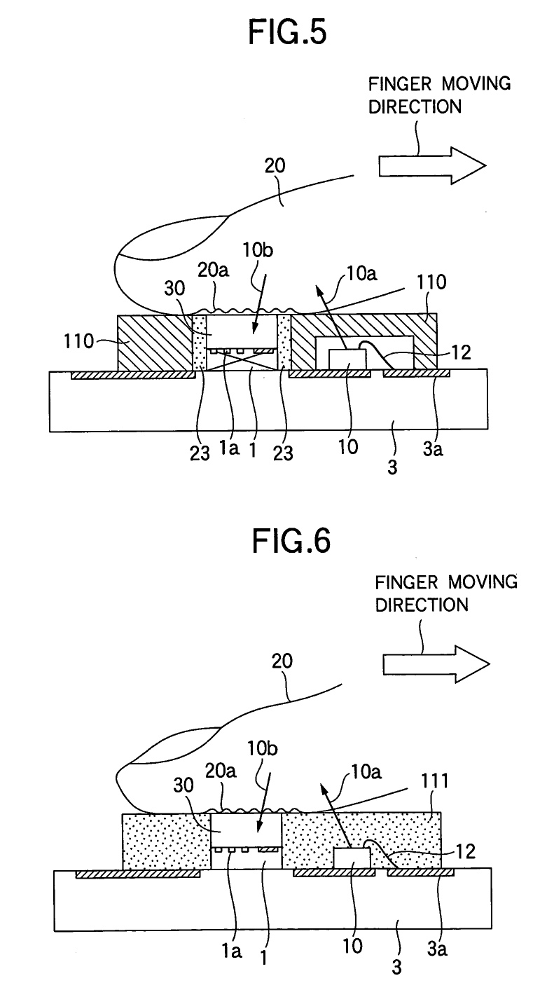

FIG. 5 is a cross sectional view showing a fingerprint input apparatus according to the third embodiment.

Although the fingerprint input apparatus shown in FIG. 5 has a whole construction similar to that of the second embodiment (refer to FIGS. 3 and 4), it differs with respect to: a point that the frame-shaped member 110 is made of a transparent material also covers the first opening 110a which surrounds the periphery of the LED chip 10 on the side where it faces the finger 20 (the upper side in the diagram) and the smoother finger moving surface is constructed; and a point that the portion between the frame-shaped member 110 and the solid state image pickup device substrate 1 is coated with a resin 23.

The resin 23 is a resin having light shielding performance, and this resin covers side surface portions of the solid state image pickup device substrate 1 and the protective layer 30 and cuts at least the unnecessary light from the LED chips 10. Epoxy, silicone, acrylic resin, or the like in which a pigment, dye, or the like has been mixed can be used as such a resin. So long as the resin has a light shielding function, the sealing resin 22 (refer to FIGS. 2 and 4) which covers the wire 21 for electrically connecting the solid state image pickup device substrate 1 and the wiring substrate 3 can be also used in common. After the frame-shaped member 110 is arranged on the wiring substrate 3, by flowing the resin 23 into the frame portion of the frame-shaped member 110, the apparatus can be easily manufactured.

According to the third embodiment, therefore, in addition to the effects of the first and second embodiments, the following advantages can be obtained.

1) Since the continuous surface where the finger moves is further increased larger than that in the second embodiment, the clearer image can be obtained.

2) Since the LED chip 10 is covered with the frame-shaped member 110, the durability against an external force and a foreign matter from the outside is enhanced.

3) Since the continuous surface is smooth, if the is dirtied, it can be easily swept, so that the clear image can be read, and the like.

(Fourth Embodiment)

FIG. 6 is a cross sectional view showing a fingerprint input apparatus according to the fourth embodiment.

The fingerprint input apparatus shown in FIG. 6 has a whole construction similar to that of the third embodiment (refer to FIG. 5) and is further characterized in that the member 110 is made by molding.

The solid state image pickup device substrate 1 and the wiring substrate 3 are electrically connected by wire bonding or the like (not shown). The LED chip 10 is also electrically connected by the wire 12 by wire bonding. After that, while the protective layer 30 is come into pressure contact with a die, the resin is injected, molded, and hardened, and the member 110 is formed, thereby simultaneously performing the sealing of the wire portion and the realization of the flatness.

An acrylic resin, epoxy resin, urethane resin, silicone resin, liquid crystal polymer resin, or the like can be used for the member 110. If those resins can transmit the light of the LED chip 10 as a light source, it is not always necessary that they are transparent.

Thus, the very smooth surface can be formed without causing a gap between the member 110 and the solid state image pickup device substrate 1. Since the sealing of the wire portion and the flatness can be simultaneously realized, the manufacturing steps are simplified and the apparatus of high reliability and low costs can be provided.

As a molding method, although the protective layer 30 is come into pressure contact with the die, it is desirable that the die of the contact portion of the protective layer 30 has a movable structure in order to absorb variations in thicknesses of the wiring substrate 3, the solid state image pickup device substrate 1, and the protective layer 30. It is also preferable to use a method called FAM (Film Assisted Molding) whereby a film is sandwiched between the die and the protective layer 30, a thickness is absorbed, and mold releasing performance is assured.

(Fifth Embodiment)

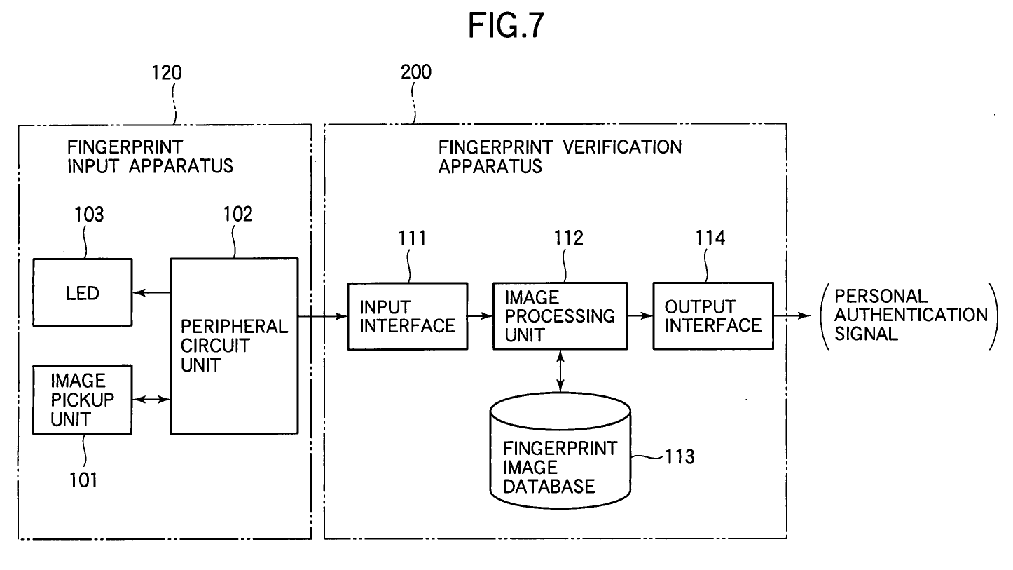

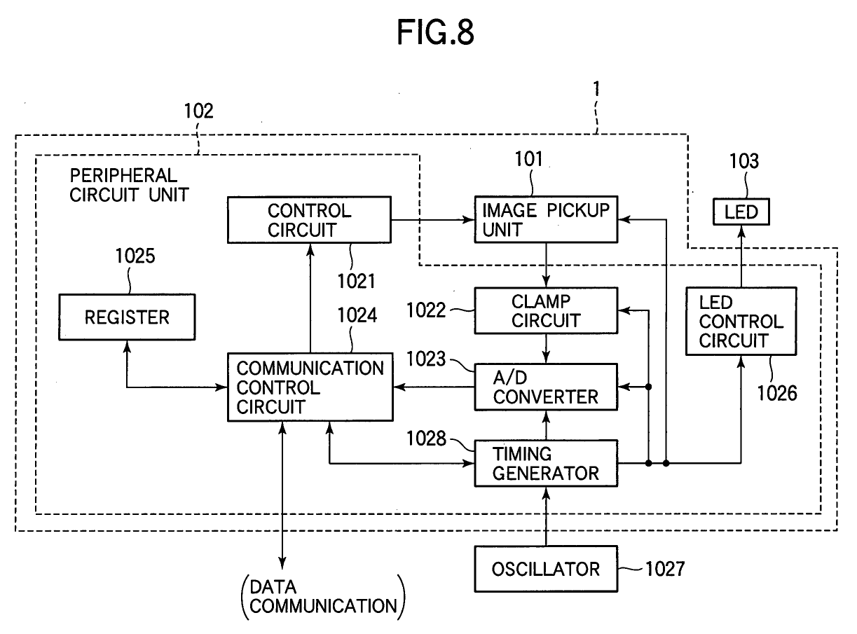

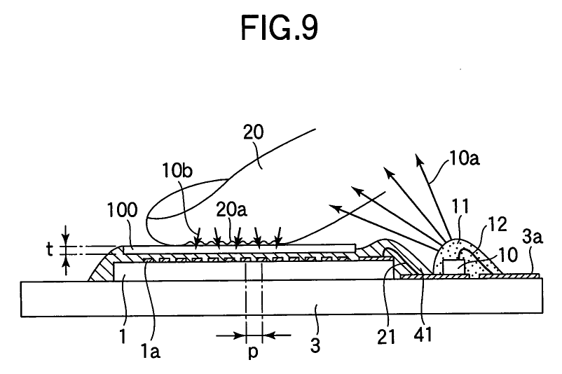

An embodiment of a personal authentication system using the fingerprint input apparatus will now be described with reference to FIGS. 7 and 8.

The personal authentication system shown in FIG. 7 comprises: a fingerprint input apparatus 120 having an image pickup unit 101 constructed by the solid state image pickup devices 1a mentioned above, its peripheral circuit unit 102, and an LED 103 mounted on the foregoing LED chip 10; and a fingerprint verification apparatus 200 connected to the fingerprint input apparatus 120.

The peripheral circuit unit 102 is formed on the solid state image pickup device substrate 1 or the like. As shown in FIG. 8, the peripheral circuit unit 102 includes: a control circuit (driving circuit) 1021 for controlling the operation of the solid state image pickup unit 101; an A/D converter 1023 for converting an analog image pickup signal according to an image regarding a fingerprint of the finger which is outputted from the image pickup unit 101 into a digital signal through a clamp circuit 1022; a communication control circuit 1024 for data-communicating the digital signal converted by the A/D converter 1023, as an image signal of the fingerprint, with an external apparatus (an interface or the like); a register 1025 connected to the communication control circuit 1024; an LED control circuit 1026 for controlling light emission of the LED 103; and a timing generator 1028 for generating control pulses for controlling operation timing of the circuits 1021 to 1026 on the basis of reference pulses which are supplied from an external oscillator 1027. The circuit including the peripheral circuit unit 102 is not limited to the above-mentioned circuit but can also includes another kind of circuit. On the other hand, a part of the above circuit can be also constructed by another chip (not shown).

The fingerprint verification apparatus 200 comprises: an input interface 111 for inputting the communication data which is outputted from a communication control unit of the peripheral circuit unit 102; an image processing unit (fingerprint verifying means) 112 connected to the input I/F 111; a fingerprint image database (fingerprint registering means) 113 connected to the image processing unit 112; and an output interface 114. The output I/F 114 is connected to an electronic apparatus (also including software) in which personal authentication is necessary in order to assure the security or the like at the time of use, log-in, or the like.

Fingerprint images of the fingers of target persons to be personal-authenticated have previously been registered in the fingerprint image database 13. There are one or a plurality of target persons. The fingerprint image of the target person is previously inputted as personal authentication information of the target person from the fingerprint input apparatus 120 through the input I/F 111 at the time of initial setting, addition of the target person, or the like.

The image processing unit 112 inputs the fingerprint image read out by the fingerprint input apparatus 120 through the input I/F 111, verifies whether it coincides with the image registered in the fingerprint image database 113 or not on the basis of the known image processing algorithm for fingerprint verification, and outputs a verification result (coincidence or dissidence of the fingerprint) as a personal authentication signal through the output I/F 114.

In this example, although the fingerprint input apparatus 120 and the fingerprint verification apparatus 200 are constructed by the different devices, the invention is not limited to them but at least a part of the functions of the fingerprint verification apparatus 200 can be also implemented in the peripheral circuit unit 102 of the fingerprint input apparatus 120 as necessary. The personal authentication system in the example can be constructed by being integratedly assembled into an electronic apparatus in which the personal authentication is necessary or can be constructed separately from the electronic apparatus.

As mentioned above, according to the invention, the fingerprint input apparatus which is smaller than the conventional one and in which a stable and fine image can be obtained can be provided at a reasonable price.

What is claimed is:

1. A fingerprint input apparatus comprising:
solid state image pickup devices;
illuminating means for emitting light into a finger;
a solid state image pickup device substrate on which said solid state image pickup devices are arranged; and
a wiring substrate on which said solid state image pickup device substrate and said illuminating means are arranged,
in which the light emitter from the illuminating means and scattered from an inside of the finger is received by said solid state image pickup devices, thereby reading a fingerprint image of said finger,
wherein said fingerprint input apparatus further comprises a member which is arranged on said wiring substrate at least in a position between said illuminating means and said solid state image pickup device substrate, said member has the same or almost the same height as that of a surface of said solid state image pickup device substrate with which said finger is come into contact and spatially partitions said illuminating means and said solid state image pickup devices, and positions of said finger and said solid state image pickup device are relatively moved, thereby reading the fingerprint image.

2. An apparatus according to claim 1, wherein after said solid state image pickup device substrate is electrically connected to said wiring substrate, said member is arranged by molding so as to also seal said electrical connecting portion.

3. An apparatus according to claim 1, wherein said member shields said solid state image pickup devices from at least unnecessary light other than the light which is emitted from said illuminating means into said finger.

4. An apparatus according to claim 1, wherein said member is formed into a frame shape which surrounds peripheries of said solid state image pickup device substrate and said illuminating means.

5. An apparatus according to claim 4, wherein a resin is filled into a frame of said member formed in said frame shape and hardened.

6. An apparatus according to claim 5, wherein said resin is made of a material which can shield at least the light of said illuminating means.

7. An apparatus according to claim 1, wherein said illuminating means is means for emitting an infrared ray and/or a near-infrared radiation.

8. An apparatus according to claim 7, wherein a silicon substrate is arranged as a protective member onto the surface of said solid state image pickup device substrate with which a fingertip is come into contact.

9. An apparatus according to claim 8, wherein a thickness of said silicon substrate is equal to or larger than 30 μm and is equal to or smaller than 200 μm.

10. An apparatus according to claim 1, wherein said member has conductive means.

11. A personal authentication system using the fingerprint input apparatus according to claim 1.

12. A system according to claim 11, further comprising:
fingerprint registering means for previously registering the fingerprint image of said finger read out by said fingerprint input apparatus as identification information of a specimen; and
fingerprint verifying means for verifying whether the fingerprint image of said finger read out by said fingerprint input apparatus coincides with the image registered in said fingerprint registering means or not and outputting a verification result as a personal authentication signal.
